(19) United States
(12) Patent Application Publication
(10) Pub. No.: US 2023/0374837 A1
(43) Pub. Date: Nov. 23, 2023

(54) MOTORIZED SLIDING FOLDING PANEL MECHANISM

(71) Applicant: STOPER ENDÜSTRIYEL ÜRÜNLER SANAYI TICARET LIMITED SIRKETI, Pendik/Istanbul (TR)

(72) Inventor: Nijat Akdemir, Pendik/Istanbul (TR)

(73) Assignee: STOPER ENDÜSTRIYEL ÜRÜNLER SANAYI TICARET LIMITED SIRKETI, Pendik/Istanbul (TR)

(21) Appl. No.: 17/913,254

(22) PCT Filed: Mar. 23, 2020
(86) PCT No.: PCT/TR2020/000002

§ 371 Date: Sep. 21, 2022

(51) Int. Cl. E05F 15/605; E06B 3/48; E05F 15/652

(52) U.S. Cl. CPC E05F 15/605; E06B 3/481; E05F 15/652; E05Y 2201/64; E05Y 2201/656; E05Y 2201/684; E05Y 2201/702; E05Y 2201/704; E05Y 2201/716; E05Y 2900/132; E05Y 2900/146

(57) ABSTRACT

A mechanism (A) that is used in moveable facades and shutter systems, garage doors and access systems is provided, allowing opening and closing of panels (P) positioned between rail profile (10) and lower rail (R).

### TECHNICAL FIELD

Invention is related with panel mechanisms used in moving façades such as sunshades, etc., shutter systems, garage doors and access systems.

In particular, the invention is related with a smooth and rigid panel mechanism allowing panels that slide open and close by sliding on the rail to open and lock with a single motor.

### STATE OF THE ART

Sliding folding movable façade and shutter systems are widely used systems in order to manage the sun rays indoors and at the same time provide adequate comfort about heat and light. Sliding folding mobile facade and shutter systems allow control of the sunlight, help obtaining a modern appearance outside the facade in addition to providing extra security in the building.

In the present state of the art, movable facade and shutter systems generally consist of interconnected panels that slide and fold on the rail. Mechanism structure for transmission of panel movement is equipped with systems like belt or steel rope. In addition to the use of more than one electric motor depending on the number of panels used in the system, there is a separate electric motor that allows the panels to be locked when closed. It increases the possibility of failure in the system due to the electric motors used for each panel in the mobile facade and shutter systems and also for the locking system. At the same time, the assembly of movable facade and shutter systems requires extra labour due to the complex mounting mechanism of these electric motors. In addition, after the installation of the system, adjustment is required for both the operating mechanism and the locking mechanism. Considering operating conditions in a work site, any adjustment made on the site causes huge time and labour loss as well as high costs. Due to operating mechanism of the systems in the state of the art, the number of panels used in the system must be in the form of 2 and its increments. Therefore, a single number of panel combination is not possible in the system.

As a result, the existence of the above problems and inadequacy of the existing solutions made it necessary to make an improvement in the relevant technical field.

### PURPOSE OF THE INVENTION

The present invention relates to a motorized sliding folding panel mechanism that overcomes the aforementioned disadvantages and brings new advantages to the relevant technical field.

In particular, purpose of the invention is related with a panel mechanism allowing panels that slide open and close by sliding on the rail to open and lock with a single motor.

Objective of the invention is to obtain a panel mechanism that allows comfortable and secure use through rigid operation without shocks and also prevents noise and vibration during windy weather.

Another purpose of the invention is to obtain a panel mechanism, which reduces the possibility of failure in addition to the cost of failure by locking the panels through opening and closing operation with a single motor.

Another purpose of the invention is to obtain a panel mechanism that enables the panels to be stopped with human force in case of human jamming between the panels by locking the panels through opening and closing operation with a single motor.

Another purpose of the invention is to obtain a panel mechanism that is quick and practical to install.

Another purpose of the invention is to obtain a panel mechanism that makes it possible to use single and double number of panels.

In order to achieve all the objectives related with the aforementioned detailed description, the invention is related with a mechanism that is used in moveable facades and shutter systems, garage doors and access systems, allowing opening and closing of panels positioned between rail profile and lower rail. Features of the invention are:
motor connected to the rail profile;
motor gear connected to one end of the motor and rotated with the motor;
rail gear connected with motor gear and rotating with motor gear,
shaft connected to the rail gear and rotating on the horizontal axis within the rail profile by means of the rail gear,
fixed carriage connected to the shaft edge on the housing of fixed carriage and positioned in the horizontal axis in the housing of fixed carriage which allows transmission of the rotating movement transmitted from the shaft via worm gear to the first panel connected on the vertical axis via spur gear of the fixed carriage on the vertical axis in the fixed carriage housing;
the use of moving carriage's right gear and moving carriage's left gear that apply pushing and pulling force to panels connected by changing the axis of the rotating movement in the vertical axis upon transmission with the left worm gear of the moving carriage or right worm gear of the moving carriage located in the horizontal axis in the moving carriage's housing that moves forward and backwards on the shaft and performing forward moving and backwards sliding on the shaft, and transmitting to the other panels connected to the first panel.

The structural and characteristic features and all advantages of the invention will be clearly understood in reference to the figures below and the detailed description written with reference to these figures. For this reason, evaluation should be made in reference to these figures and detailed explanations.

### FIGURES SERVING AS REFERENCE TO COMPREHEND THE INVENTION

FIG. 1: Perspective view of the disassembled mechanism of the invention.

FIG. 2: Perspective view of the fixed carriage belonging to the mechanism of the invention in disassembled form.

FIG. 3: Perspective view of disassembled form of left gear of the moving carriage and right gear of the moving carriage belonging to the invention mechanism.

FIG. 4: Perspective view of panels belonging to invention mechanism in disassembled form.

FIG. 5: Perspective view of folding movement of panels belonging to invention mechanism.

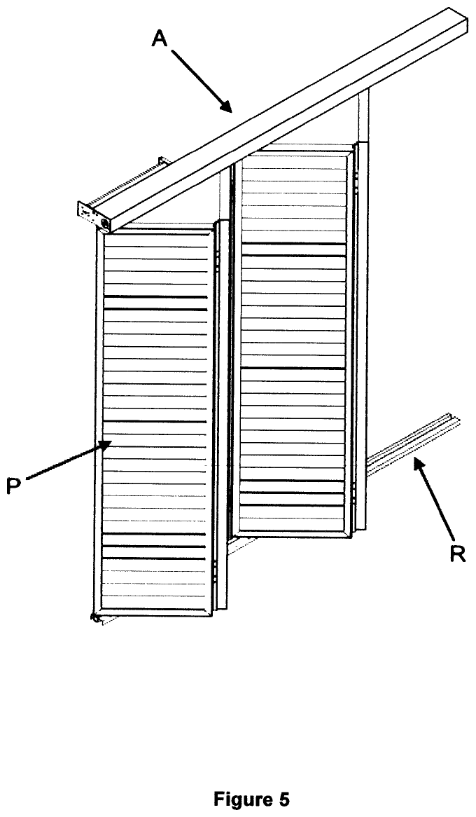

FIG. 6: Perspective view of the folded panels belonging to invention mechanism.

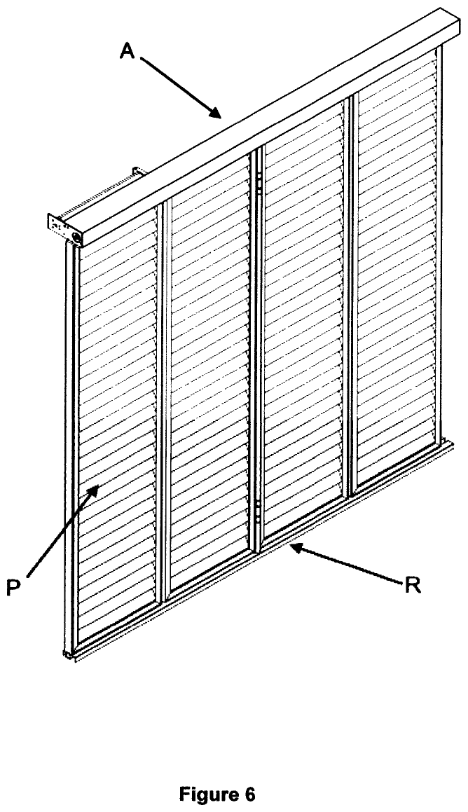

### DESCRIPTION OF PART REFERENCES

10 Rail profile
20 Motor
30 Motor gear
40 Rail gear
50 Chain
60 Shaft
70 Roller bearing
80 Bearing shell
90 Fixed carriage
91 Housing of fixed carriage
92 Worm gear of fixed carriage
93 Worm gear bearing of fixed carriage
94 Square shafts bearing of fixed carriage
95 Roller of worm gear bearing of fixed carriage
96 Cover plate of fixed carriage
97 Spur gear bearing of fixed carriage
98 Spur gear of fixed carriage
99 Fixed carriage bearing shell
991 Cover plate of fixed carriage
992 Fixed carriage thrust ball bearing
993 Fixed carriage spur gear shaft
994 Fixed carriage wedge
100 Fixed carriage plate
110a. Moving carriage right gear
110b. Moving carriage left gear
111 Moving carriage housing
112a. Moving carriage right worm gear
112b. Moving carriage left worm gear
113 Worm gear bearing of moving carriage
114 Square shaft bearing of moving carriage
115 Moving carriage square shaft roller bearing
116 Roller of worm gear bearing of moving carriage
117 Moving carriage side cover plate
118 Spur gear bearing of moving carriage
119a. Moving carriage right spur gear
119b. Moving carriage left spur gear
1191 Moving carriage bearing shell
1192 Moving carriage top cover plate
1193 Moving carriage thrust ball bearing
1194 Moving carriage spur gear shaft
1195 Moving carriage wedge
1196 Moving carriage wheel
120 Cover
130 Fixed cover
A. Mechanism
P. Panel
R. Bottom rail

### DETAILED DESCRIPTION OF INVENTION

In this detailed description, preferred alternatives to the mechanism (A) of the present invention are described only for a better understanding of the invention and without creating any limiting effects.

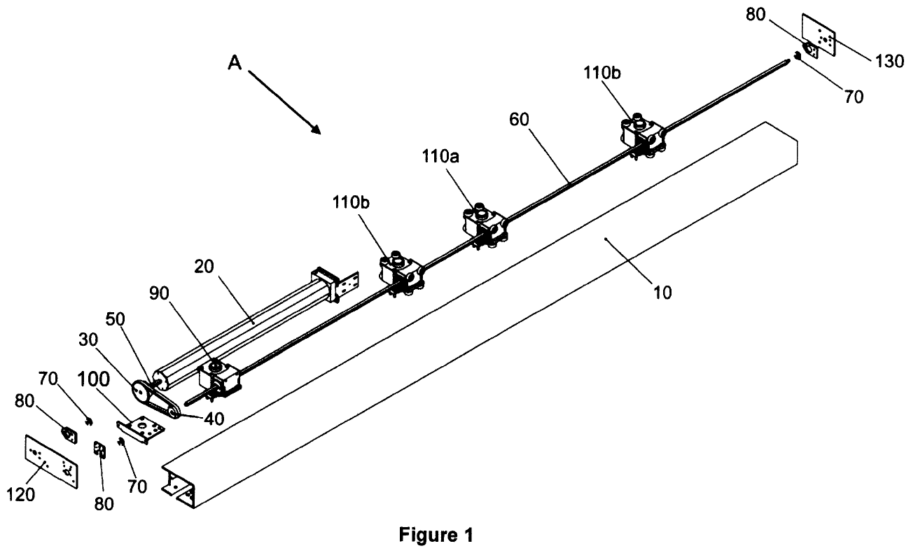

FIG. 1 shows the disassembled illustration of the mechanism (A) of the invention. Accordingly, in its most basic form, mechanism (A) consists of a rail profile (10), motor (20) connected to rail profile (10), motor gear (30) connected to one end of the motor (20) and rotating with the motor (20), rail gear (40) connected to motor gear (30) with chain (50) and rotating with the motor gear (30), shaft (60) rotating on the horizontal axis in the rail profile (10) through rail gear (40) and connected to rail gear (40), fixed carriage (90) that is fixed on the shaft (60) edge with fixed carriage plate (100) and transmitting the rotating movement received from the shaft (60) to the first panel (P) connected upon changing rotating axis, moving carriage right gear (110a) and moving carriage left gear (110b) that move by sliding forward and backwards on the shaft (60), applies pulling and pushing force to panels (P) connected by transmitting the rotating movement received from shaft (60) to other panels connected to the first panel upon changing axis of the movement.

Rail profile (10) is the main structure of the invention mechanism (A) that allows panels (P) to connect with the operating profile.

Motor (20) that operates the mechanism (A) is connected to the rail profile (10). Motor gear (30) is connected to the end of the motor (20) with roller bearing (70) and bearing shell (80). Motor gear (30) in question rotates by means of motor (20). Rail gear (40) is connected to motor gear (30) by means of chain (50). Rail gear (40) rotates with motor gear (30). Motor gear (60) is connected to the rail gear (40) with roller bearing (70) and bearing shell (80). Shaft (60) is rotated in rail profile (10) of the shaft (60) by means of rail gear (40) and motor gear (30) rotating with the thrust of the motor (20).

Fixed carriage (90) is connected to the edge of the shaft (60) rotating in the rail profile (10) by means of fixed carriage plate (100). Fixed carriage (90) procures that axis of the rotating movement received from the shaft (60) is changed and the movement is transmitted to the first panel (P) connected on the edge of the mechanism (A) and that the first panel connected (P) only opens and closes without making forward and backwards sliding movement on mechanism (A) as it is fixed on the edge of the shaft (60).

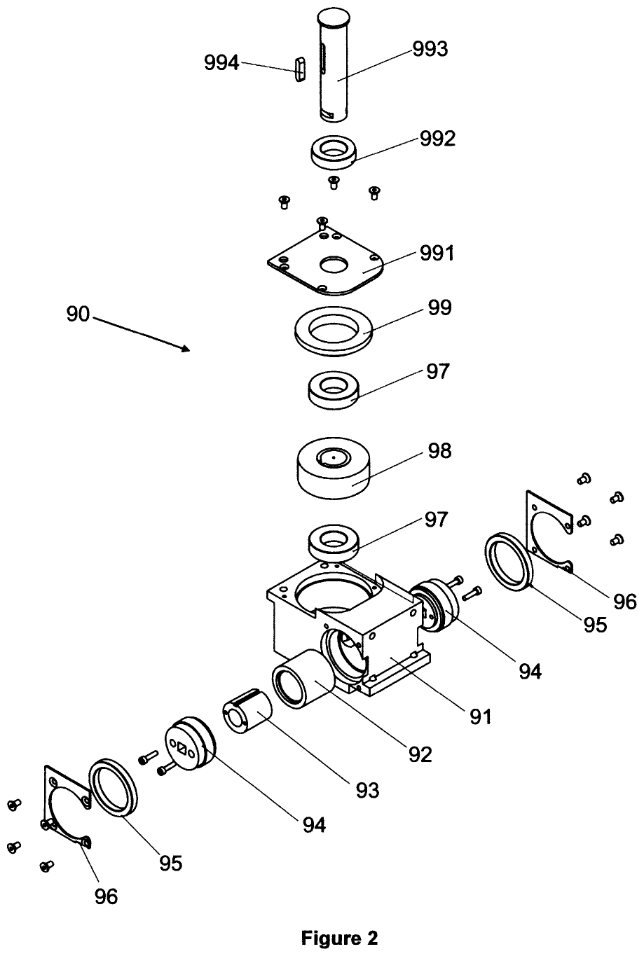

As FIG. 2 shows, fixed carriage (90) generally consists of fixed carriage housing (91) connected with the fixed carriage plate (100) on the shaft (60); fixed carriage worm gear (92) that rotates by means of shaft (60) and is connected in the horizontal axis such that rotating movement is made by means of worm gear bearing (93) in the fixed carriage housing (91), fixed carriage square shaft bearing (94) located on both sides of the fixed carriage worm gear (92) in the fixed carriage housing (91) that transmits rotating movement received from the shaft (60) to fixed carriage worm gear (92), fixed carriage worm gear bearing (93) that is located on both sides of the fixed carriage worm gear (92), serving as bearing for fixed carriage worm gear (92), fixed carriage worm gear bearing (93), fixed carriage square shaft bearing (94) and fixed carriage housing (91); fixed carriage spur gear (98) that is connected on both side surfaces of the fixed carriage housing (91), connected to the fixed carriage cover plate (96) stabilizing fixed carriage worm gear (92) in the centre of the fixed carriage housing (91) on the vertical axis in the fixed carriage housing (91) and changing rotating movement of the fixed carriage worm gear (92) in the horizontal axis to vertical axis by rotating by means of fixed carriage worm gear (92), fixed carriage roller bearing (99) that is located on the top and bottom surface of the fixed gear spur gear (98), carrying lateral loads applied to fixed carriage spur gear (98), fixed carriage cover plate (991) that is connected to the top surface of the fixed carriage housing (91) and fixing the fixed carriage spur gear (98) on the fixed carriage housing (91), fixed carriage thrust ball bearing (992) that is located on the fixed carriage housing (91), absorbing load of the panel (P) connected to the fixed carriage (90), fixed carriage spur gear (993) connected to the fixed carriage spur gear (98) over the fixed carriage thrust ball bearing (992) by means of fixed carriage wedge (994), transmitting rotating movement taken from fixed carriage spur gear (98) to the first panel (P) connected to the bottom end.

Moving carriage right gear (110a) and moving carriage left gear (110b) is connected to the shaft (60) rotating in the rail profile (10) in order to procure that other panels (P) connected to the first panel (P) open and close by sliding and folding on the rail profile (10). The number of moving carriage right gear (110a) and moving carriage left gear (110b) may be increased or decreased depending on the number of panels (P).

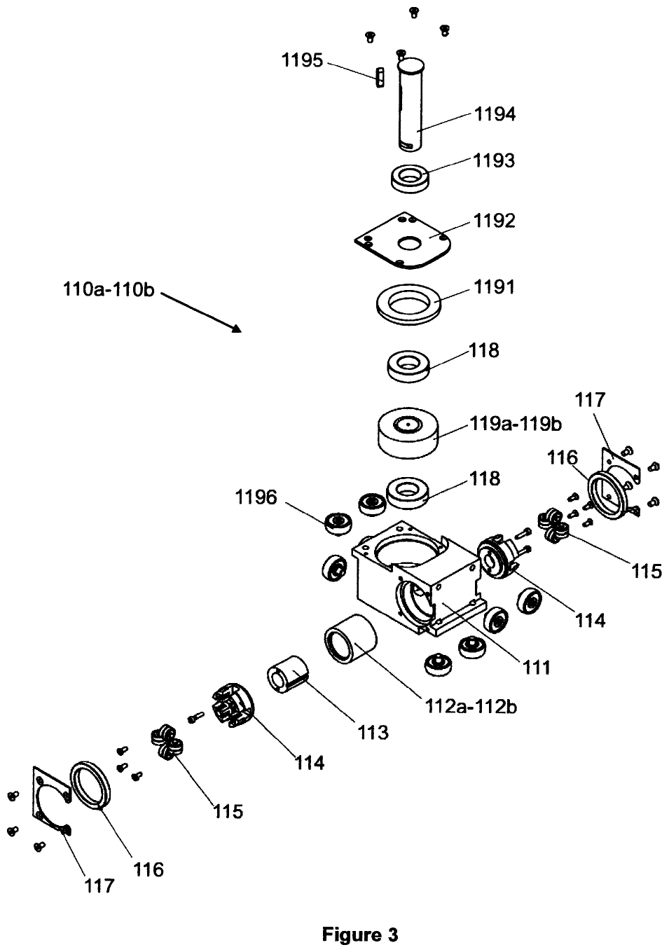

As FIG. 3 shows, in general, moving carriage right gear (110a) and moving carriage left gear (110b) consist of moving carriage housing (111) connected in a manner allowing forward and backwards sliding movement on the shaft (60); moving carriage right worm gear (112a) or moving carriage left worm gear (112b) connected in the moving carriage housing (111) on the horizontal axis, allowing rotating movement by means of moving carriage worm gear bearing (113) and rotating by means of shaft (60), moving carriage square shaft bearing shell (114) that is located on both side surfaces of moving carriage right worm gear (112a) or moving carriage left worm gear (112b) in the moving carriage housing (111), transmitting the rotating movement taken from shaft (60) to moving carriage right worm gear (112a) or moving carriage left worm gear (112b), moving carriage square shaft rotating bearing shell (115) located in the moving carriage square shaft bearing (114), performing rotating and sliding movement in the shaft (60), allowing forward and backwards sliding of the moving carriage right gear (110a) and moving carriage left gear (110b) on the shaft (60), moving carriage worm gear bearing (116) that is located on both sides of the moving carriage housing (111) and housing moving carriage right worm gear (112a) or moving carriage left worm gear (112b), moving carriage worm gear bearing (113), moving carriage square shaft roller bearing (114), moving carriage side cover plate (117) that is connected to both side surfaces of moving carriage housing (111) and fixing moving carriage right worm gear (112a) or moving carriage left worm gear (112b) to the centre of the moving carriage housing (111), moving carriage right spur gear (119a) or moving carriage left spur gear (119b) that is connected to the moving carriage housing (111) on the vertical axis and rotating by means of moving carriage right worm gear (112a) and moving carriage left worm gear (112b), changing rotating movement of moving carriage right worm gear (112a) and moving carriage left worm gear (112b) in the horizontal axis into the vertical axis, spur gear roller bearing (118) that is located on the top and bottom surface of moving carriage left spur gear (119a) or moving carriage left spur gear (119b), carrying lateral loads applied on the moving carriage right spur gear (119a) and moving carriage left spur gear (119b), moving carriage bearing shell (1191) located on the top surface of the moving carriage housing (111), serving as bearing for the moving carriage right spur gear (119a) and moving carriage left spur gear (119b), moving carriage top cover plate (1192) fixing moving carriage right spur gear (119a) or moving carriage left spur gear (119b) connected to the top surface of the moving carriage housing (111) onto the moving carriage housing (111), moving carriage thrust ball bearing (1993) that is located on the moving carriage housing (111), absorbing load of the panel (P) connected to the moving carriage right gear (110a) and moving carriage left gear (110b), moving carriage spur gear shaft (1194) connected to the moving carriage right spur gear (119a) or moving carriage left spur gear (119b) over the moving carriage thrust ball bearing (1193) by means of moving carriage wedge (1195) and transmitting rotating movement taken from moving carriage right gear (119a) or moving carriage left gear (119b) to the panel (P) connected to the bottom end, moving carriage wheel (1196) connected to the external surface of moving carriage housing (111), causing moving carriage right gear (110a) and moving carriage right gear (110b) to slide forward and backwards by absorbing lateral movements in the rail profile (10).

Cover (120) is mounted on the edge of the rail profile (10) with fixed carriage and fixed cover (130) is mounted on the other edge, ensuring that shaft (60) is housed in the rail profile (10) by means of the roller bearing (70) and bearing shell (80), covering both edges of the rail profile (10).

Operating Principle of the Invention Mechanism (A) is as Provided Below:

Panels (P) are connected to the mechanism (A) on the top and rail (R) on the bottom. Shaft (60) is rotated in the rail profile (10) by means of motor gear rotating upon starting the motor (20) and rail gear (40) connected to motor gear (30) by means of chain.

With the rotation of the motor (60), fixed carriage worm gear (92) in the fixed carriage (90), moving carriage right worm gear (112a) in the moving carriage right gear (110a) and moving carriage left worm gear (112b) in the moving carriage left gear (110b) rotate.

With the rotating movement of the moving carriage right gear (112a), moving carriage right gear (110a) and with the rotating movement of the moving carriage left gear (112b), moving carriage left gear slide and move by means of moving carriage square shaft rotating roller bearing (115) in the moving carriage square shaft bearing shell (114) on the shaft (60). Meanwhile, fixed carriage (90) remains stable as it is connected to the shaft (60) with fixed carriage plate (100); however, fixed carriage worm gear (92) in the fixed carriage (90) rotates.

Moving carriage right worm gear (112a) in the moving carriage right gear (110a) transmits the rotating movement performed on the horizontal axis to the moving carriage right spur gear (119a), moving carriage left worm gear (112b) in the moving carriage left gear (110b) transmits the rotating movement performed on the horizontal axis to the moving carriage left spur gear (119b), and fixed carriage worm gear (92) in the fixed carriage (90) transmits the rotating movement performed in the horizontal axis to fixed carriage spur gear (98).

Moving carriage right spur gear (119a) and moving carriage left spur gear (119b) changes the rotating movement on the horizontal axis into the vertical axis and transmits to the moving carriage spur gear shaft (1194). At the same time, fixed carriage spur gear (98) changes rotating movement on the horizontal axis into the vertical axis and transmits to fixed carriage spur gear shaft (993).

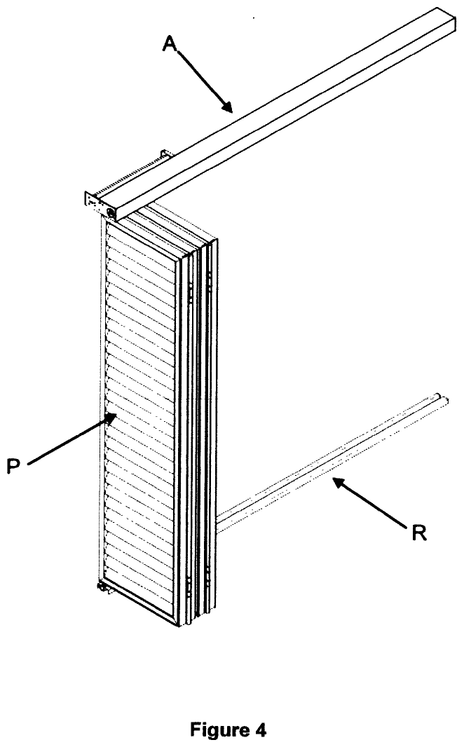

First panel (P) connected to the bottom end of the fixed carriage spur gear shaft (993) and other panels (P) connected to the bottom end of the moving carriage spur gear (1194) rotate. Thus, during the sliding movement of the moving carriage right gear (110a) and moving carriage left gear (110b) on the shaft (60), panels (P) fold and open and close by rotating as shown in FIG. 4 with the pushing and pulling force applied by moving carriage right spur gear (119a), moving carriage left spur gear (119b) and fixed carriage spur gear (98) to each other.

1. A mechanism (A) that is used in moveable facades and shutter systems, garage doors and access systems, allowing opening and closing of panels (P) positioned between rail profile (10) and lower rail (R), comprises:
a motor (20) connected to the rail profile (10),
a motor gear (30) connected to one end of the motor (20) and rotated with the motor (20);
a rail gear (40) connected with motor gear (30) and rotating with motor gear (30), shaft (60) connected to the rail gear (40) and rotating on the horizontal axis within the rail profile (10) by means of the rail gear (40),
a fixed carriage (90) connected to the shaft edge on the housing of fixed carriage (91) and positioned in the horizontal axis in the housing of fixed carriage (91) which allows transmission of the rotating movement transmitted from the shaft (60) via worm gear (92) to the first panel connected on the vertical axis via spur gear of the fixed carriage (98) on the vertical axis in the fixed carriage housing(91);
a moving carriage having a right gear (110a) and a left gear (110b) that apply pushing and pulling force to panels (P) connected by changing the axis of the rotating movement in the vertical axis upon transmission with the left worm gear of the moving carriage (112a) or right gear of the moving carriage (112b) located in the horizontal axis in housing (111) for the moving carriage that moves forward and backwards on the shaft (60) and performing forward moving and backwards sliding on the shaft (60), and transmitting to the other panels (P) connected to the first panel (P) by means of the moving carriage right spur gear (119a) and moving carriage left spur gear (119b).

2. The mechanism (A) of claim 1 further comprising a chain (50) that is positioned on the motor gear (30) and the rail gear (40) and connecting the motor gear (30) and the rail gear (40) to each other.

3. The mechanism (A) of claim 1 wherein the fixed carriage worm gear (92) that is connected with the fixed carriage housing (91) by means of the fixed carriage worm gear bearing (93) in the horizontal axis for the purpose of rotating movement achieved with the shaft (60).

4. The mechanism (A) of claim 1 further comprising fixed carriage square shaft bearing (94) that is positioned on both side surfaces of the fixed carriage worm gear (92) and transmitting the rotating movement taken from the shaft (60) to the fixed carriage worm gear (92).

5. The mechanism (A) of claim 1 further comprising a fixed carriage cover plate (96) connected to both side surfaces of the fixed carriage housing (91), fixing the fixed carriage worm gear (92) to the centre of the fixed carriage housing (91).

6. The mechanism (A) of claim 1 further comprising a fixed carriage spur gear (98) that is connected to the fixed carriage housing (91) in the vertical axis and rotating by means of fixed carriage worm gear (92) in order to change rotating movement of fixed carriage worm gear (92) in the horizontal axis to the vertical axis.

7. The mechanism (A) of claim 1 further comprising a fixed carriage spur gear bearing (97) positioned on the bottom and top surface of the fixed carriage spur gear (98), carrying lateral loads applied to fixed carriage spur gear (98).

8. The mechanism (A) of claim 1 further comprising a fixed carriage cover plate (96) connected to top surface of the fixed carriage housing (91), fixing fixed carriage spur gear (92) to the centre of the fixed carriage housing (91).

9. The mechanism (A) of claim 1 further comprising a fixed carriage thrust ball bearing (992) that is positioned on the fixed carriage housing (91), absorbing load of the panel (P) connected to the fixed carriage (90).

10. The mechanism (A) of claim 1 further comprising a fixed carriage spur gear shaft (993) connected to the fixed carriage spur gear (98), transmitting the rotating movement taken from fixed carriage spur gear (98) to the first panel (P) connected to the bottom end.

11. (canceled)

12. The mechanism (A) of claim 1 wherein moving the carriage right worm gear (112a) or moving the carriage left worm gear (112b) connected to the moving carriage housing (111) by means of moving the carriage worm gear bearing (113) in the horizontal axis for performing rotating movement, turning by means of the shaft (60).

13. The mechanism (A) of claim 1 further comprising a moving carriage square shaft bearing shell (114) that is positioned on both side surfaces of the moving carriage right worm gear (112a) or the moving carriage left worm gear (112b) in the moving carriage housing (111), transmitting rotating movement taken from shaft (60) to the moving carriage right worm gear (112a) or moving carriage left worm gear (112b).

14. The mechanism (A) of claim 13 further comprising a moving carriage square shaft roller bearing (115) that is positioned in the moving carriage shaft bearing shell (114), ensuring the moving carriage right gear (110a) and the moving carriage left gear (110b) to slide forward and backwards on the shaft (60) by performing rotating and sliding movement on the shaft (60).

15. The mechanism (A) of claim 1 further comprising a moving carriage side cover plate (117) connected to both side surfaces of the moving carriage housing (111) and fixing moving carriage right worm gear (112a) or moving carriage left worm gear (112b) to the centre of the moving carriage housing (111).

16. The mechanism (A) of claim 1 further comprising a moving carriage right spur gear (119a) or moving carriage left spur gear (119b) that is connected to the moving carriage housing (11) in the vertical axis, rotating by means of the moving carriage right worm gear (112a) or the moving carriage left worm gear (112b), changing rotating movement of the moving carriage right worm gear (112a) or moving carriage left worm gear (112b) in the horizontal axis to the vertical axis.

17. The mechanism (A) of claim 1 further comprising a moving carriage spur gear bearing (118) that is positioned on the top and bottom surface of the moving carriage right spur gear (119a) or the moving carriage left spur gear (119b), carrying lateral loads applied to the moving carriage right spur gear (119a) or moving carriage left spur gear (119b).

18. The mechanism (A) of claim 1 further comprising a moving carriage top cover plate (1192) that is connected to top surface of the moving carriage housing (111), fixing moving carriage right spur gear (119a) or moving carriage left spur gear (119b) to the moving carriage housing (111).

19. The mechanism (A) of claim 1 further comprising a moving carriage thrust ball bearing (1993) that is positioned on the moving carriage housing (111), absorbing load of the panel (P) connected to the moving carriage right gear (110a) and moving carriage left gear (110b).

20. The mechanism (A) of claim 1 further comprising a moving carriage spur gear shaft (1194) that is connected to the moving carriage right spur gear (119a) or moving carriage left spur gear (119b), transmitting the rotating movement taken from moving carriage right spur gear (119a) or moving carriage left spur gear (119b) to panel (P) connected to the bottom end.

21. (canceled)

22. The mechanism (A) of claim 1 further comprising a moving carriage wheel (1196) connected to the external surface of the moving carriage housing (111), allowing forward and backwards sliding of moving carriage right gear (110a) and moving carriage left gear (110b) in the rail profile (10) by absorbing lateral loads.
